(19) United States
(12) Patent Application Publication
(10) Pub. No.: US 2017/0171150 A1
(43) Pub. Date: Jun. 15, 2017

(54) METHOD AND APPARATUS FOR PROCESSING PUBLIC IP

(71) Applicants: Le Holdings (Beijing) Co., Ltd., Beijing (CN); LeCloud Computing Co., Ltd., Beijing (CN)

(72) Inventor: Yong SHANG, Beijing (CN)

(21) Appl. No.: 15/246,517

(22) Filed: Aug. 24, 2016

Related U.S. Application Data
(63) Continuation of application No. PCT/CN2016/088867, filed on Jul. 6, 2016.

(30) Foreign Application Priority Data
Dec. 14, 2015 (CN) 201510926345.4

(51) Int. Cl. H04L 29/12; H04L 12/66; H04L 29/08

(52) U.S. Cl. CPC H04L 61/2514; H04L 67/10; H04L 12/66

(57) ABSTRACT

Disclosed are a method and an apparatus for processing public IP. The method for processing public IP includes: acquiring a gateway IP address; generating a floating IP according to the gateway IP address, a floating IP address in the floating IP being the gateway IP address; binding the gateway IP address and the floating IP; and processing the floating IP according to a floating IP interface.

### CROSS REFERENCE TO RELATED APPLICATIONS

This application is a continuation of International Application No. PCT/CN2016/088867, filed on Jul. 6, 2016, which is based upon and claims priority to Chinese Patent Application No. 201510926345.4, filed on Dec. 14, 2015, the entire contents of which are incorporated herein by reference.

### TECHNICAL FIELD

The present disclosure relates to information technologies, and more particularly, to a method and an apparatus for processing public IP.

### BACKGROUND

In networks managed by OpenStack Neutron, there are two concepts: a router gateway IP and a floating IP, both of them belong to the same network segment, namely, both the router gateway IP and the floating IP belong to public IPs. By default, in an implementation method for OpenStack, the router gateway IP and the floating IP are differentially treated, and an operation interface is respectively provided for them. For example, a router interface is used to operate a gateway, and a floating IP interface is used to operate the floating IP.

At present, two sets of application program interfaces (APIs) need to be developed for operation of a public IP, for example, setting up a public-network bandwidth, where one set is developed for the router gateway IP, and the other set is developed for the floating IP. To increase a function in counting public network traffic, another two sets of APIs need to be respectively developed for the router gateway IP and the floating IP. Namely, two sets of APIs need to be developed every time a function is added for the public IP, which not only multiplies extra workload but also increases maintenance cost, thereby increasing an error probability.

### SUMMARY

The present disclosure provides a method and an apparatus for processing public IP, which are intended to reduce extra workload generated during processing an existing public IP.

In a first aspect, embodiments of the present disclosure provide a method for processing public IP, implemented by a server, including:

acquiring a gateway IP address;

generating a floating IP according to the gateway IP address, a floating IP address in the floating IP being the gateway IP address;

binding the gateway IP address and the floating IP; and

processing the floating IP according to a floating IP interface.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for processing public IP mentioned by embodiments of the present disclosure.

In a third aspect, embodiments of the present disclosure provide a non-transitory computer-readable storage medium storing executable instructions that, when executed by an electronic device, cause the electronic device to perform any methods for processing public IP mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for processing public IP in accordance with some embodiments;

FIG. 2 is a flowchart of another method for processing public IP in accordance with some embodiments;

FIG. 3 is a structural block diagram of an apparatus for processing public IP in accordance with some embodiments;

FIG. 4 is a structural block diagram of another apparatus for processing public IP in accordance with some embodiments;

FIG. 5 is a schematic diagram of an entity structure of a server in accordance with some embodiments; and

FIG. 6 is a block diagram of an electronic device in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

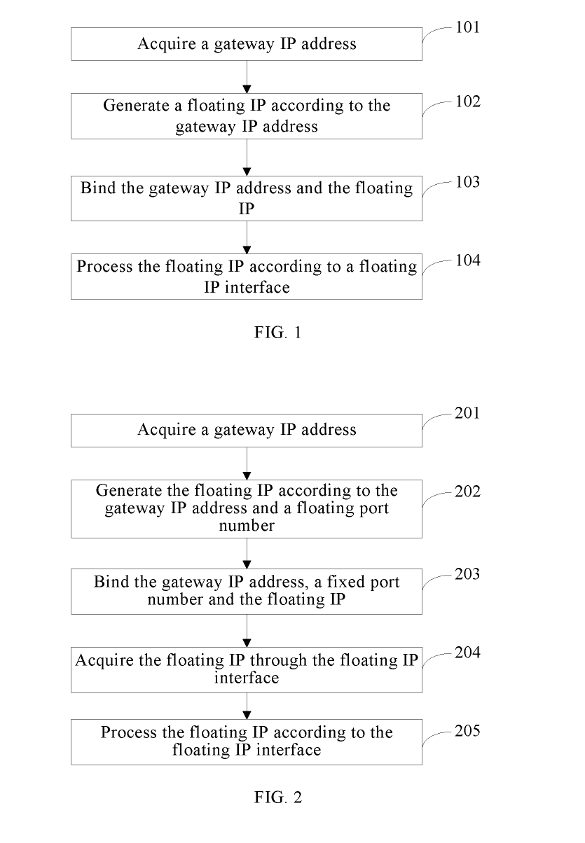

Embodiments of the present disclosure provide a method for processing public IP, implemented by a server, as shown in FIG. 1, the method specifically includes following steps:

101: a server acquires a gateway IP address.

The gateway IP address in essence is an IP address through which one network is connected to other networks, and the gateway IP address is a fixed IP address. It should be noted that in networks managed by OpenStack, a gateway IP address and a floating IP belong to public IPs. By default, in an implementation method for OpenStack, the gateway IP and the floating IP are differentially treated, and an operation interface is respectively provided for them. For example, a router interface is used to operate the gateway IP, and a floating IP interface is used to operate the floating IP.

102: the server generates the floating IP according to the gateway IP address.

A floating IP address in the floating IP is the gateway IP address. It is to be noted that a format of the floating IP is (a floating IP address, a floating portID, a fixed IP address, a fixed portID), where the floating portID is a floating port number, the fixed portID is a fixed port number, and the floating port number and the fixed port number are automatically allocated by a system when a public IP is set up.

For example, if the acquired gateway IP address is 10.11.1.254, the floating IP generated according to the gateway IP address specifically is (10.11.1.254, 11111, null, null). It is to be noted that 10.11.1.254 in the floating IP represents a floating IP address, 11111 represents a floating port number, positions of two subsequent values respectively represent a fixed IP address and a fixed portID, and the positions of the two null values are used to subsequently bind the gateway IP address.

103: the server binds the gateway IP address and the floating IP.

In the embodiments of the present disclosure, binding the gateway IP address and the floating IP is to correspondingly fill the gateway IP address and a fixed interface number into the generated floating IP. For example, if the generated floating IP is (10.11.1.254, 11111, null, null), after the gateway IP address and the floating IP are bound, the floating IP specifically can be (10.11.1.254, 11111, 10.11.1.254, 22222). As can be seen from the foregoing example, after the gateway IP address and the floating IP are bound, a floating IP address in the floating IP is the same as the fixed IP address, namely, the gateway IP address. Therefore, in subsequent steps, operation of the gateway IP address can be implemented by means of the floating IP generated through operation of the floating IP interface, namely through the floating IP interface.

104: the server processes the floating IP according to the floating IP interface.

It is to be noted that processing the floating IP specifically may include: setting up bandwidth of the floating IP, counting traffic of the floating IP, increasing functions and so on, which are not specifically limited in the embodiments of the present disclosure.

To the embodiments of the present disclosure, applicable scenarios are shown as below, including but not limited to: if it is necessary to count traffic corresponding to a public IP in OpenStack, it is required to respectively count traffic corresponding to the gateway IP and traffic corresponding to the floating IP, and then the traffic corresponding to the public IP can be obtained according to a sum of the traffic corresponding to the gateway IP and the traffic corresponding to the floating IP. The traffic corresponding to the floating IP can be directly acquired through a floating IP interface. Whereas to count the traffic corresponding to the gateway IP, first of all, it is required to convert a gateway IP into a floating IP, where a floating IP address in the floating IP is the gateway IP address, then the floating IP and the gateway IP address are bound, and at last the generated floating IP is invoked through a floating interface. In this way, it is implemented to acquire the traffic corresponding to the gateway IP through the floating interface without creating an interface corresponding to the gateway IP, thereby reducing extra workload generated during counting public IP traffic through the present disclosure.

Corresponding to the foregoing method, embodiments of the present disclosure further provide a method for processing public IP, implemented by a server, as shown in FIG. 2, the method specifically includes following steps:

201: a server acquires a gateway IP address.

To the embodiments of the present disclosure, the acquiring the gateway IP address includes: receiving setup router gateway request information; creating a virtual network interface corresponding to the router gateway request information; and acquiring the gateway IP address according to the virtual network interface.

202: the server generates the floating IP according to the gateway IP address and a floating port number.

A floating IP address in the floating IP is the gateway IP address. A format of the floating IP is (a floating IP address, a floating portID, a fixed IP address, a fixed portID). Therefore, when the floating IP is generated, it is still needed to acquire a floating port number, and then the floating IP is generated according to the gateway IP address and the floating port number. It is to be noted that the floating port number is automatically generated by a system and thus can be directly acquired. For example, if the acquired gateway IP address is 10.11.1.151 and the floating port number is 11111, the floating IP generated according to the gateway IP address and the floating port number specifically is (10.11.1.151, 11111, null, null).

203: the server binds the gateway IP address, a fixed port number and the floating IP.

For example, if the acquired gateway IP address is 10.11.1.112 and the floating port number is 11111, the floating IP generated according to the gateway IP address and the floating port number specifically is (10.11.1.112, 11111, null, null). If the fixed port number is 22222, after the gateway IP address, the fixed port number and the floating IP are bound, the floating IP specifically is (10.11.1.112, 11111, 10.11.1.112, 22222).

It is to be noted that a first IP address 10.11.1. 112 in the floating IP represents a floating IP address, 11111 represents a floating port number, a latter IP address 10.11.1.112 in the floating IP represents a fixed IP address, and 22222 represents a fixed port number.

204: the server acquires the floating IP through the floating IP interface.

205: the server processes the floating IP according to the floating IP interface.

To the embodiments of the present disclosure, when operation is performed on a public IP, a floating IP in the public network can be processed through a floating IP interface. Whereas to process a gateway IP address in the public network, first of all a floating IP needs to be generated according to the gateway IP address and a fixed port number, where a floating IP address in the generated floating IP is the same as the gateway IP address, then the generated floating IP, the gateway IP address and the fixed port number are bound, and at last the floating IP generated according to the gateway IP address and the fixed port number is operated for an interface developed for the floating IP. In this way, operation of the floating IP and the gateway IP can be completed merely through the floating IP interface without an interface developed for the gateway IP, thereby reducing extra workload generated during processing the public IP.

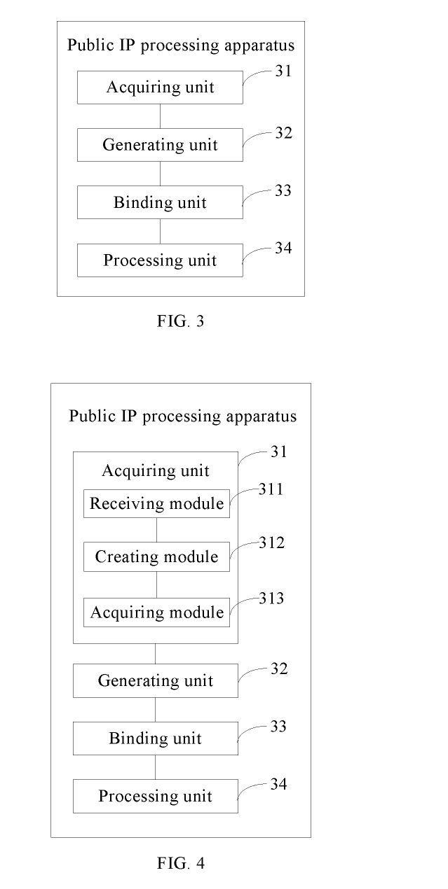

Further, as implementation of the foregoing method, embodiments of the present disclosure provide an apparatus for processing public IP, as shown in FIG. 3, the apparatus includes: an acquiring unit, a generating unit, a binding unit and a processing unit.

The acquiring unit 31 is configured to acquire a gateway IP address.

The generating unit 32 is configured to generate a floating IP according to the gateway IP address acquired by the acquiring unit 31, where a floating IP address in the floating IP is the gateway IP address. The gateway IP address in essence is an IP address through which one network is connected to other networks, and the gateway IP address is a fixed IP address. It is to be noted that in networks managed by OpenStack, a gateway IP address and a floating IP belong to public IPs. By default, in an implementation method for OpenStack, the gateway IP and the floating IP are differentially treated, and an operation interface is respectively provided for them. For example, a router interface is used to operate the gateway IP, and a floating IP interface is used to operate the floating IP.

The binding unit 33 is configured to bind the gateway IP address and the floating IP generated by the generating unit 32; a format of the floating IP is (a floating IP address, a floating portID, a fixed IP address, a fixed portID), where the floating portID is a floating port number, the fixed portID is a fixed port number, and the floating port number and the fixed port number are automatically allocated by a system when a public IP is set up.

The processing unit 34 is configured to process the floating IP according to a floating IP interface. Processing the floating IP specifically may include: setting up bandwidth of the floating IP, counting traffic of the floating IP, increasing functions and so on, which are not specifically limited in the embodiments of the present disclosure.

Further, the acquiring unit 31 includes:

a receiving module 311, configured to receive setup router gateway request information;

a creating module 312, configured to create a virtual network interface corresponding to the router gateway request information received by the receiving module 311; and

an acquiring module 313, configured to acquire the gateway IP address according to the virtual network interface created by the creating module 312.

The acquiring unit 31 is further configured to acquire the floating IP according to the floating IP interface.

The generating unit 32 is specifically configured to generate the floating IP according to the gateway IP address and a floating port number. A format of the floating IP is (a floating IP address, a floating portID, a fixed IP address, a fixed portID). Therefore, when the floating IP is generated, it is still needed to acquire a floating port number, and then the floating IP is generated according to the gateway IP address and the floating port number. It is to be noted that the floating port number is automatically generated by a system and thus can be directly acquired. For example, if the acquired gateway IP address is 10.11.1.151 and the floating port number is 11111, the floating IP generated according to the gateway IP address and the floating port number specifically is (10.11.1.151, 11111, null, null).

The binding unit 33 is specifically configured to bind the gateway IP address, a fixed port number and the floating IP. For example, if the acquired gateway IP address is 10.11.1.112 and the floating port number is 11111, the floating IP generated according to the gateway IP address and the floating port number specifically is (10.11.1.112, 11111, null, null). If the fixed port number is 22222, after the gateway IP address, the fixed port number and the floating IP are bound, the floating IP specifically is (10.11.1.112, 11111, 10.11.1.112, 22222).

In conclusion, by using the method for processing public IP and the apparatus provided by the embodiments of the present disclosure, first of all a gateway IP address is acquired, then a floating IP is generated according to the gateway IP address, where a floating IP address in the floating IP is the gateway IP address, then the gateway IP address and the floating IP are bound, and at last the floating IP is processed according to a floating IP interface. Compared with current technologies in which two sets of interfaces need to be developed for operation of a public IP, namely one set of interface is developed for a gateway IP and the other set of interface is developed for a floating IP, in embodiments of the present disclosure, when operation is performed on a public IP, first of all, a gateway IP address is converted into a special floating IP, where a floating IP address in the floating IP is the same as the gateway IP address, then the gateway IP address and the floating IP are bound, and at last the floating IP is processed according to a floating IP interface. Therefore, by means of the present disclosure, an interface developed for a floating IP can be directly invoked to operate the special floating IP, namely, the floating IP generated through the gateway IP. Thus, in the present disclosure, operation of the floating IP and the gateway IP can be completed merely through a floating IP interface, thereby avoiding an interface developed for the gateway IP and reducing extra workload generated during processing a public IP.

It is to be noted that in allusion to the apparatus for processing public IP, functions of each unit module used in the embodiments of the present disclosure can be implemented through a hardware processor.

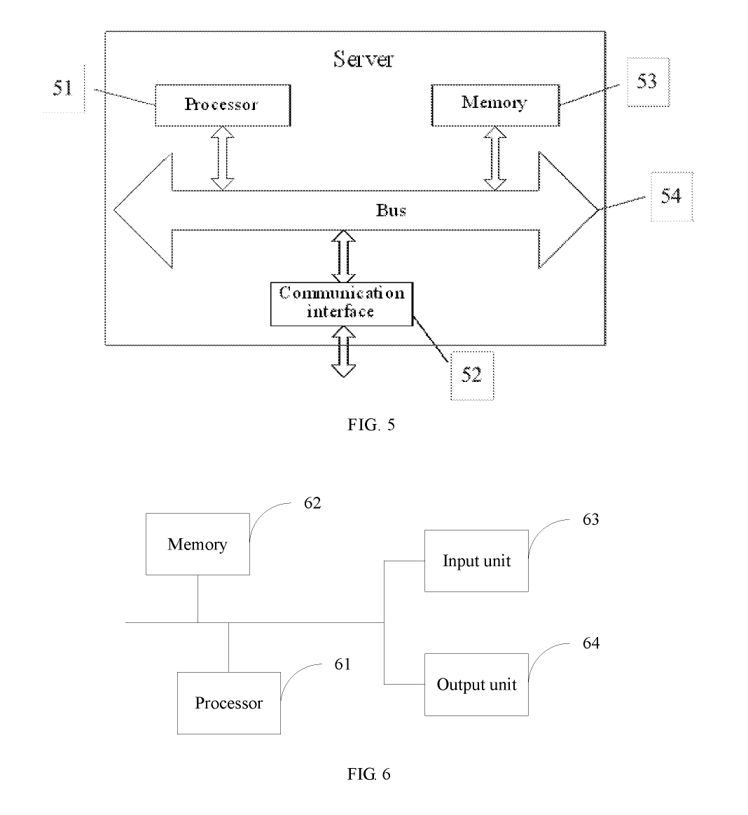

Exemplarily, as shown in FIG. 5, which shows a schematic diagram of an entity structure of a server according to embodiments of the present disclosure, the server can include: a processor 51, a communications interface 52, a memory 53 and a bus 54, where the processor 51, the communications interface 52 and the memory 53 complete communications among each other through the bus 54. The communications interface 52 can be configured to implement information transmission between the server and the client. The processor 51 can invoke a logic instruction in the memory 53 to execute the following method: acquiring a gateway IP address; generating a floating IP according to the gateway IP address, a floating IP address in the floating IP being the gateway IP address; binding the gateway IP address and the floating IP; and processing the floating IP according to a floating IP interface.

In addition, when a logic instruction in the foregoing memory 53 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for processing public IP mentioned by embodiments of the present disclosure.

FIG. 6 is a block diagram of an electronic device which is configured to perform the methods for processing public IP according to an embodiment of the present disclosure. As shown in FIG. 6, the device includes: one or more processors 61 and memory 62. A processor 61 is showed in FIG. 6 for an example.

Device which is configured to perform the methods for processing public IP can also include: input unit 63 and output unit 64.

Processor 61, memory 62, input unit 63 and output unit 64 can be connected by BUS or other methods, and BUS connecting is showed in FIG. 6 for an example.

Memory 62 can be used for storing non-transitory software program, non-transitory computer executable program and modules as a non-transitory computer-readable storage medium, such as corresponding program instructions/modules for the methods for processing public IP mentioned by embodiments of the present disclosure (such as shown in FIG. 3, acquiring unit 31, generating unit 32, binding unit 33 and processing unit 34). Processor 61 performs kinds of functions and processing public IP of the electronic device by executing non-transitory software program, instructions and modules which are stored in memory 62, thereby realizes the methods for processing public IP mentioned by embodiments of the present disclosure.

Memory 62 can include program storage area and data storage area, thereby the operating system and applications required by at least one function can be stored in program storage area and data created by using the device for processing public IP can be stored in data storage area. Furthermore, memory 62 can include high speed Random-access memory (RAM) or non-volatile memory such as magnetic disk storage device, flash memory device or other non-volatile solid state storage devices. In some embodiments, memory 62 can include long-distance setup memories relative to processor 61, which can communicate with the device for processing public IP by networks. The examples of said networks are including but not limited to Internet, Intranet, LAN, mobile Internet and their combinations.

Input unit 63 can be used to receive inputted number, character information and key signals causing user configures and function controls of the device for processing public IP. Output unit 64 can include a display screen or a display device.

The said module or modules are stored in memory 62 and perform the methods for processing public IP when executed by one or more processors 61.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for processing public IP, implemented by a server, comprising:
acquiring a gateway IP address;
generating a floating IP according to the gateway IP address, a floating IP address in the floating IP being the gateway IP address;
binding the gateway IP address and the floating IP; and
processing the floating IP according to a floating IP interface.

2. The method according to claim 1, wherein the acquiring a gateway IP address comprises:
receiving setup router gateway request information;
creating a virtual network interface corresponding to the router gateway request information; and
acquiring the gateway IP address according to the virtual network interface.

3. The method according to claim 2, wherein before the processing the floating IP address according to a floating IP interface, the method further comprises:
acquiring the floating IP according to the floating IP interface.

4. The method according to claim 3, wherein the generating a floating IP according to the gateway IP address comprises:
generating the floating IP according to the gateway IP address and a floating port number.

5. The method according to claim 4, wherein the binding the gateway IP address and the floating IP comprises:
binding the gateway IP address, a fixed port number and the floating IP.

6. An electronic device, comprising:
at least one processor; and
a memory communicably connected with the at least one processor for storing instructions executable by the at least one processor, wherein execution of the instructions by the at least one processor causes the at least one processor to:
acquire a gateway IP address;
generate a floating IP according to the gateway IP address, a floating IP address in the floating IP being the gateway IP address;
bind the gateway IP address and the floating IP; and
process the floating IP according to a floating IP interface.

7. The electronic device according to claim 6, wherein the acquiring a gateway IP address comprises:
receiving setup router gateway request information;
creating a virtual network interface corresponding to the router gateway request information; and
acquiring the gateway IP address according to the virtual network interface.

8. The electronic device according to claim 7, wherein before the processing the floating IP address according to a floating IP interface, wherein the instructions are executed to cause the at least one processor to:
acquire the floating IP according to the floating IP interface.

9. The electronic device according to claim 8, wherein the generating a floating IP according to the gateway IP address comprises:
generating the floating IP according to the gateway IP address and a floating port number.

10. The electronic device according to claim 9, wherein the binding the gateway IP address and the floating IP comprises:
binding the gateway IP address, a fixed port number and the floating IP.

11. A non-transitory computer-readable storage medium storing executable instructions that, when executed by an electronic device, cause the electronic device to:
acquire a gateway IP address;
generate a floating IP according to the gateway IP address, a floating IP address in the floating IP being the gateway IP address;
bind the gateway IP address and the floating IP; and
process the floating IP according to a floating IP interface.

12. The non-transitory computer-readable storage medium according to claim 11, wherein the acquiring a gateway IP address comprises:
receiving setup router gateway request information;
creating a virtual network interface corresponding to the router gateway request information; and
acquiring the gateway IP address according to the virtual network interface.

13. The non-transitory computer-readable storage medium according to claim 12, wherein before the processing the floating IP address according to a floating IP interface, wherein the executable instructions are executed to cause the electronic device to:
acquire the floating IP according to the floating IP interface.

14. The non-transitory computer-readable storage medium according to claim 13, wherein the generating a floating IP according to the gateway IP address comprises:
generating the floating IP according to the gateway IP address and a floating port number.

15. The non-transitory computer-readable storage medium according to claim 14, wherein the binding the gateway IP address and the floating IP comprises:
binding the gateway IP address, a fixed port number and the floating IP.
